(19) United States
(12) Patent Application Publication
(10) Pub. No.: US 2006/0268926 A1
(43) Pub. Date: Nov. 30, 2006

(54) Wireless interface encapsulator/decapsulator for emulating IEEE-488 interface bus with wireless protection and quality of service

(76) Inventor: Farouk M. Zanaty, Palm Bay, FL (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/137,413

(22) Filed: May 26, 2005

(51) Int. Cl. H04L 12/66

(52) U.S. Cl. 370/463

(57) ABSTRACT

A wireless card for use in a host operating in a wireless network is provided with an IEEE-488 interface bus; and a wireless interface including a transverser provided to transmit and receive radio signals from multiple wireless sources in parallel, while maintaining backward compatibility with the IEEE-488 interface bus. This way the wireless card can advantageously be built to comply with wireless transmission needs, while retaining all benefits associating with the existing IEEE-488 interface bus to provide positive financial impacts for both vendors and consumers.

### BACKGROUND

In general, modern computer controlled measurement systems are utilized to perform a variety of functions, including, for example, process monitoring and control, test and analysis of physical phenomena and control of mechanical or electrical characteristics. A typical computer controlled measurement system 100, as shown in FIG. 1, includes a PC or workstation (controller) 110 equipped with a controller card, and different types of measurement devices (peripherals or instruments) 120A-120D equipped with an I/O interface. There are several I/O interface options available for allowing communication among various instruments and devices in such a computer controlled measurement system. However, the most popular and versatile I/O interface is a general purpose interface bus (GPIB), otherwise referred to as the Institute of Electrical and Electronic Engineers IEEE-488 interface bus, designed in accordance with IEEE standard 488.1 and 488.2-1987 “Standard Digital Interface for Programmable Instrumentation” to provide networking or remote control of programmable instruments and measurement devices.

Specifically, IEEE-488.1 standard defines mechanical, hardware, and electrical protocol specifications for the interconnection of programmable or controllable instruments. IEEE-488.2 standard provides a minimum set of requirements for controller and device capabilities (talker, listener and/or controller), and defines data coding and formats, message and communication protocol structures between controller and device. However, the IEEE-488 interface specification also has a set of limitations, such as, for example, a maximum data transfer rate (bus bandwidth) of 1 megabyte per second (MB/s) with each transaction carrying one byte (8 bits) at time, up to 15 devices to be interconnected in any given setup on one bus, and a maximum total bus (cable) length of 20 meters with a distance between devices up to 2 meters. The cabling and data speed limitations along with a limited set of controllable instruments usable in such a computer controlled measurement system can be burdensome and undesirable, particularly, when wireless technology has matured and becomes increasingly popular in recent years. An example of such wireless technology is the so-called “Wireless HotSpots”, also known as Wi-Fi access points (“APs”) as specified in accordance with IEEE 802.11(a), 802.11(b) and/or 802.11(g) standards, to allow users to connect to the Internet, via mobile devices such as laptops, PDA and the like. Such access points (APs) are provided with wireless capabilities relative to the controllable instruments to access a wireless local area network (WLAN) in order to send and receive information over the Internet and/or other data networks. Such wireless technology can also provide modern computer controlled measurement systems with a greater and more efficient means to access many more remote controllable instruments with much higher data transfer speed without any cabling limitations. For example, as many as 300 controllable instruments can advantageously be utilized without any degradation of performance. In addition, a data transfer speed of at least 50-100 times faster than the IEEE-488 interface specification (e.g., up to 128 megabytes per second) can be achieved without any cabling limitations.

Accordingly, there is a need to provide a wireless interface technique and means installed in the PC or workstation (controller) and different types of measurement devices (peripherals or instruments) in a computer controlled measurement system to comply with wireless transmission needs as required by the IEEE 802.11(a), 802.11(b) and/or 802.11(g) standards for a wireless local area network, while maintaining backward compatibility with standard IEEE-488 interface bus. Also needed is an apparatus and method of operating an interface bus that is capable of receiving and transmitting IEEE-488-compliant signals from and to a set of controllable measurement devices (peripherals or instruments) sharing the bus bandwidth in the wireless domain.

### SUMMARY

Various aspects and example embodiments of the present invention advantageously provide computer controlled measurement systems and wireless interface techniques for communication between measurement devices (i.e., peripherals or instruments) from different stream sources in a wireless network.

In accordance with an aspect of the present invention, a wireless card for use in a host operating in a wireless network comprises an IEEE-488 interface bus; and a Wireless Interface provided with a Transverser to transmit and receive data and/or control streams from multiple wireless stream sources in parallel, while maintaining backward compatibility with the IEEE-488 interface bus. This way the Wireless Interface can advantageously be built to comply with wireless transmission needs, while retaining all benefits associating with the existing IEEE-488 interface bus to provide positive financial impacts for both vendors and consumers.

In accordance with an example embodiment of the present invention, the Wireless Interface comprises an Encapsulator configured to receive payload data to be transmitted, via a wireless antenna, and encapsulate the payload data with necessary header and protocol-dependent information for wireless transmission, via the antenna; and a Decapsulator configured to decapsulate all received information, via the wireless antenna, extract the payload data and prepare the payload data for digital processing. The Transverser is configured to receive up to sixteen (16) data and control streams that are transmitted in parallel in the form of packets from up to eight (8) different wireless stream sources, in compliance with the IEEE-488 interface bus. Such a Transverser is provided with a transmitter arranged to transmit a data stream and a control stream that are bidirectional in the form of packets, with each stream emulating one of sixteen (16) wires of the IEEE-488 interface bus; a receiver arranged to receive one or more data streams and control streams in the form of packets from up to eight (8) wireless stream sources, with each stream emulating one of sixteen (16) wires of the IEEE-488 interface bus; and a processing circuitry configured to perform digital processing all received information after packet decapsulation. In addition, the Transverser is further provided with an encryptor/decryptor arranged to encrypt the data and/or control stream to be transmitted, via the antenna, and to decrypt all received information, via the wireless antenna, according to “Wired Equivalent Privacy” (WEP); and an authenticator arranged to authenticate all received information using Wi-Fi Protection Access (WPA) or a second generation Wi-Fi Protection Access (WPA2) along with the Advanced Encryption Standard (AES).

In accordance with an example embodiment of the present invention, the Encapsulator and the Decapsulator are provided with an interchangible function in transmission and reception modes of operation. The Encapsulator is configured to set header information associated with a defined communication protocol for wireless communication; add individual bytes representing message information to be transmitted, via the wireless antenna, with the header information until a packet size is reached; encapsulate a checksum to combined header and message information to form a new packet encapsulating the header and message information and the checksum; and accumulate encapsulated packets until a burst of packets is obtained for transmission, via the wireless antenna. Conversely, the Decapsulator is configured to set header information associated with a defined communication protocol for wireless communication in advance; decode header information from received information in the form of packets, via the wireless antenna; read individual bytes representing message information after the header information is decoded until a packet size is reached; read the checksum from each packet to form a new packet decapsulating the header and message information and the checksum; and accumulate decapsulated packets in a buffer until a message is ready for digital signal processing.

The wireless card may correspond to one of a PCMCI (Personal Computer Memory Card International Association) card, a PCI (Peripheral Component Interconnect) card, a mini PCI card, and a USB2 (Universal Serial Bus) card installed to connect peripherals to the host. The host may correspond to either a controller or one of different types of measurement devices in a computer controlled measurement system, in which the controller serves as a wireless Access Point (AP) provided to access network resources, via the Internet, while any one of the measurement devices serves as a client station to communicate with the controller, via wireless transmission as specified by IEEE 802.11(a), 802.11(b) and/or 802.11(g) standards for a wireless local area network (WLAN).

In accordance with another aspect of the present invention, a computer controlled measurement system operable in a wireless network, comprises: a plurality of measurement devices located at different locations in a designated area of the wireless network; and a controller which serves as a wireless Access Point (AP) to control measurement of the plurality of measurement devices, via wireless communication; wherein the controller and each of the measurement devices is provided with a Wireless Interface to transmit and receive data and/or control streams representing commands or responses from multiple wireless stream sources in parallel, while maintaining backward compatibility with a standard IEEE-488 interface bus.

In accordance with an example embodiment of the present invention, the Wireless Interface is provided with a Transverser to transmit and receive data and/or control streams representing commands or responses from multiple wireless stream sources in parallel; an Encapsulator configured to receive payload data to be transmitted, via a wireless antenna, and encapsulate the payload data with necessary header and protocol-dependent information for wireless transmission, via the antenna; and a Decapsulator configured to decapsulate all received information, via the wireless antenna, extract the payload data and prepare the payload data for digital processing.

The Transverser is configured to receive up to sixteen (16) data and control streams that are transmitted in parallel in the form of packets from up to eight (8) different wireless stream sources, in compliance with the standard IEEE-488 interface bus, and comprises: a transmitter arranged to transmit a data stream and a control stream that are bidirectional in the form of packets, with each stream emulating one of sixteen (16) wires of the standard IEEE-488 interface bus; a receiver arranged to receive one or more data streams and control streams in the form of packets from up to eight (8) wireless stream sources, with each stream emulating one of sixteen (16) wires of the IEEE-488 interface bus; and a processing circuitry configured to perform digital processing all received information after packet decapsulation.

The Encapsulator may be configured to: set header information associated with a defined communication protocol for wireless communication; add individual bytes representing message information to be transmitted, via the wireless antenna, with the header information until a packet size is reached; encapsulate a checksum to combined header and message information to form a new packet encapsulating the header and message information and the checksum; and accumulate encapsulated packets until a burst of packets is obtained for transmission, via the wireless antenna. Conversely, the Decapsulator may be configured to: set header information associated with a defined communication protocol for wireless communication in advance; decode header information from received information in the form of packets, via the wireless antenna; read individual bytes representing message information after the header information is decoded until a packet size is reached; read the checksum from each packet to form a new packet decapsulating the header and message information and the checksum; and accumulate decapsulated packets in a buffer until a message is ready for digital signal processing.

In accordance with yet another aspect of the present invention, a system comprises a plurality of measurement devices located at different locations in a designated area of the wireless network; and a controller which serves as a wireless Access Point (AP) to control measurement of the plurality of measurement devices, via wireless communication; wherein the controller and each of the measurement devices is provided with a Wireless Interface to transmit and receive data and/or control streams representing commands or responses from multiple wireless stream sources in parallel, while maintaining backward compatibility with an existing standard IEEE-488 interface bus.

In addition to the example embodiments and aspects as described above, further aspects and embodiments will be apparent by reference to the drawings and by study of the following descriptions.

### BRIEF DESCRIPTION OF THE DRAWING(S)

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates a typical computer controlled measurement system;

FIG. 2 illustrates an example computer controlled measurement system operable in a wireless local area network according to an embodiment of the present invention;

FIG. 3 illustrates an example Wireless Interface Encapsulator/Decapsulator (“HotSpot Interface”) according to an embodiment of the present invention;

FIGS. 4A-4C illustrate example data streams of the Wireless HotSpot Interface coupled to the standard IEEE-488 module according to an embodiment of the present invention;

FIG. 5 illustrates example control streams of the Wireless HotSpot Interface coupled to the standard IEEE-488 module according to an embodiment of the present invention;

FIG. 6 illustrates example data and control streams of the Wireless HotSpot Interface coupled to the standard IEEE-488 module according to an embodiment of the present invention;

FIG. 7 illustrates an example interaction between Wireless Hotspot Interfaces according to an embodiment of the present invention;

FIG. 8 illustrates an example flowchart of an example Encapsulation algorithm according to an embodiment of the present invention;

FIG. 9 illustrates an example flowchart of an example Decapsulation algorithm according to an embodiment of the present invention;

FIG. 10 illustrates an example circuit diagram of a Wireless Transverser according to an embodiment of the present invention;

FIG. 11 illustrates an example data packet according to an embodiment of the present invention;

FIG. 12 illustrates an example Wireless Interface Encapsulator/Decapsulator (“HotSpot Interface”) integrated in a PCMCIA card according to an example embodiment of the present invention;

FIG. 13 illustrates an example Wireless Interface Encapsulator/Decapsulator (“HotS pot Interface”) integrated in a PCI card according to an example embodiment of the present invention;

FIG. 14 illustrates an example Wireless Interface Encapsulator/Decapsulator (“HotSpot Interface”) integrated in a mini-PCI card according to an example embodiment of the present invention; and

FIG. 15 illustrates an example Wireless Interface Encapsulator/Decapsulator (“HotSpot Interface”) integrated in a USB2 card according to an example embodiment of the present invention.

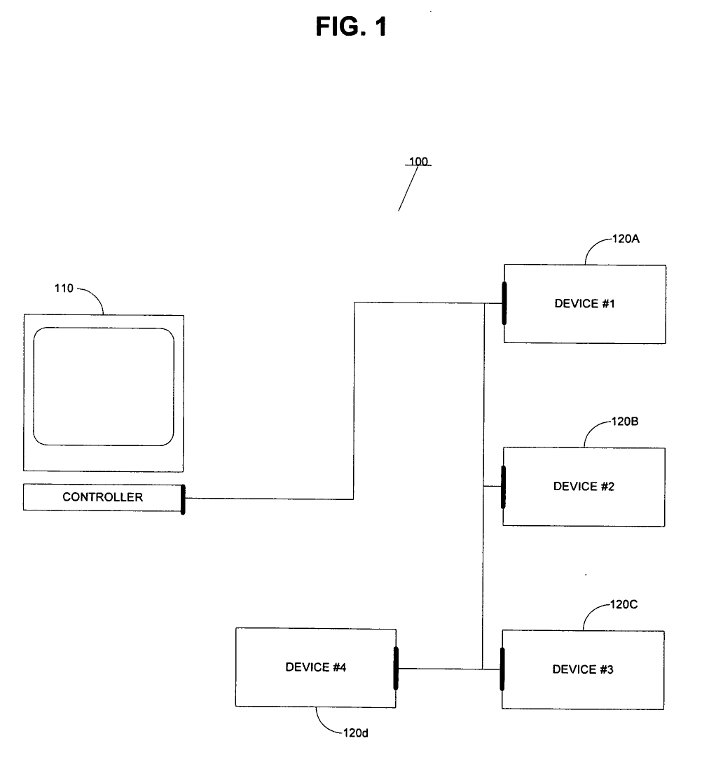

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, example sizes/values/ranges may be given, although the present invention is not limited to the same. The present invention is compatible with all devices operable with an existing IEEE-488 interface bus as specified by IEEE standard 488.1 and 488.2-1987 “Standard Digital Interface for Programmable Instrumentation”, and is applicable for use with all types of data networks, including, for example, an Integrated Systems Digital Network (ISDN), a Voice over IP (VOIP) network, the Internet, and wireless digital communication services (e.g., wireless local area networks such as Wi-Fi networks, Bluetooth, ultra-wideband networks, and compatible wireless application protocols usable for wireless transmission as specified by IEEE 802.11(a), 802.11(b) and/or 802.11(g) standards, Bluetooth standards and other wireless personal area networks. However, for the sake of simplicity, discussions will concentrate mainly on exemplary use of a measurement system operable in a wireless local area network, although the scope of the present invention is not limited thereto.

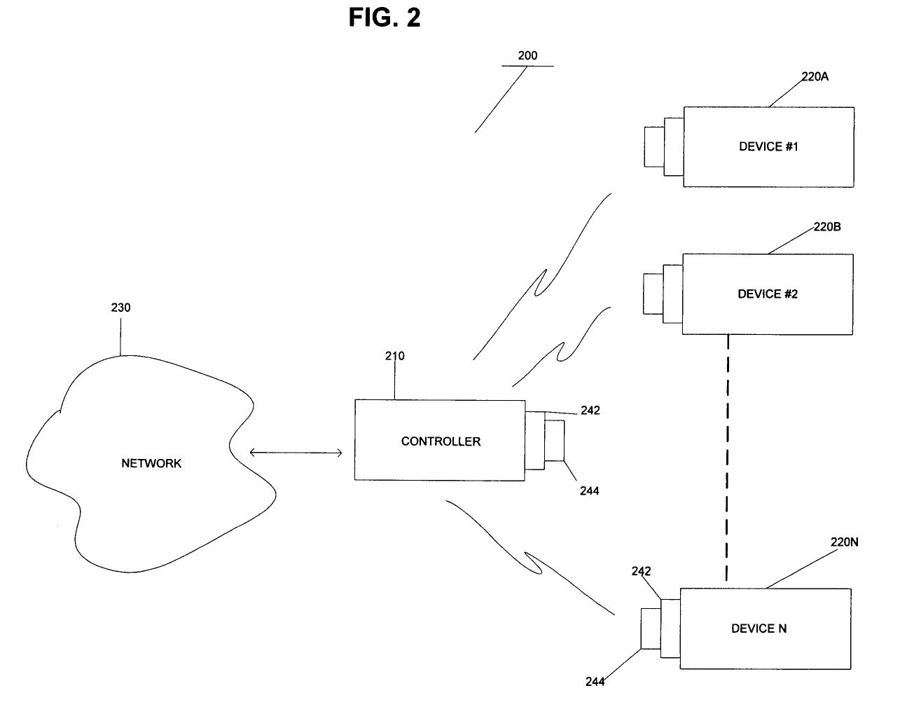

Attention now is directed to the drawings and particularly to FIG. 2, in which an example computer controlled instrument system operable in a wireless local area network according to an embodiment of the present invention is illustrated. As shown in FIG. 2, the computer controlled measurement system 200 comprises a PC or workstation (controller) 210 connected to a data network such as the Internet 230, and different types of measurement devices (peripherals or instruments) 220A-220N. The controller 210 may serve as a wireless Access Point (AP), also known as “Wireless HotSpot” provided to access network resources, via a distribution system such as the Internet 230 (not shown herein, for purposes of simplicity, are the Ethernet switch, Internet gateway, WAN/LAN interface and local server), while the measurement devices 220A-220N may act as mobile devices (“HotSpot” client stations) to communicate with the controller 210, via wireless transmission, as specified by IEEE 802.11(a), 802.11(b) and/or 802.11(g) standards for a wireless local area network (WLAN). Wireless Access Point (AP) may serve a central connection that allows a number of client stations to wirelessly connect to a network that is either created by an Access Point or a client station without having dedicated cables, and communicate according to the IEEE 802.11(a), 802.11(b) and/or 802.11(g) standards for a wireless local area network (WLAN).

Each of the controller 210 and the measurement devices 220A-220N is equipped with an existing IEEE-488 interface module 242 and a Wireless Interface Encapsulator/Decapsulator 244 referred herein as “HotSpot Interface” which is provided to perform all functions necessary to transmit, receive and execute a command from the controller 210 to one or more HotSpot client stations, i.e., measurement devices 220A-220N, such as a multimeter or a function generator programmable oscilloscope, in accordance with IEEE 802.11(a), (b) and/or (g) standards for a wireless local area network (WLAN). Radio signals transmitted from the HotSpot Interface 244 can be uni-directional or bidirectional in the wireless domain to comply with frequencies of the 2.4-5 GHz bands as dictated by 802.11(a), (b) and/or (g) standards. Such a HotSpot Interface 244 can also be utilized through its modular hardware and software combination, to perform all necessary control and handshaking signals required for the data bus to carry different commands and different responses in accordance with IEEE-488 interface bus standard. This way the relationship to the IEEE-488 can be advantageously maintained to allow different commercial products to be built to comply with the wireless transmission needs, while maintaining backward compatibility with the existing IEEE-488 interface bus and therefore provide positive financial impacts for both vendors and consumers.

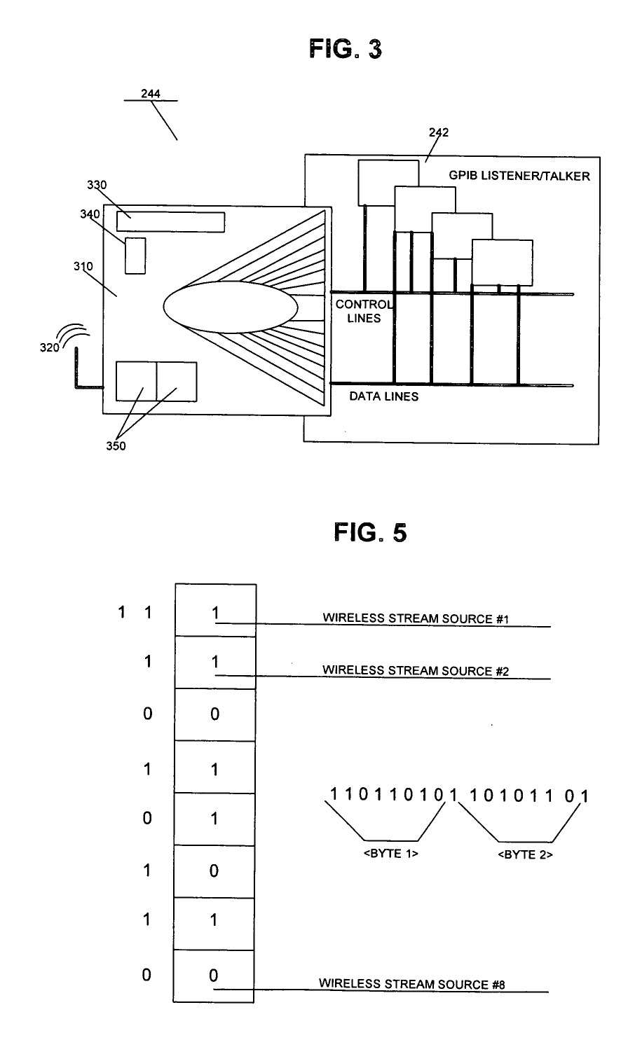

FIG. 3 illustrates an example Wireless Interface Encapsulator/Decapsulator (“HotSpot Interface”) according to an embodiment of the present invention. As shown in FIG. 3, the IEEE-488 interface module 242 represents known components of a general purpose interface bus (GPIB), known as the IEEE-488 interface bus, including eight (8) bi-directional data lines used to transfer addresses, control information and data, and eight (8) control and handshake lines used to control and acknowledge the transfer of messages and manage the flow of control and data in formats as defined by the IEEE-488 standard. Such an IEEE-488 interface module 242 may allow up to 15 devices, including the controller 210 and the measurement devices 220A-220N to be connected thereto, to act as Listeners, Talkers, and Controllers.

The HotSpot Interface 244, which is coupled to the IEEE-488 module 242, comprises a Wireless Transverser 310 coupled to a wireless antenna 320, an Encapsulator 330, a Decapsulator 340, and wireless protection and quality of service components 350, to provide dual band communications capability over the 2.4 and 5 GHz frequencies which allow simultaneous associations, control, and management of multi-instrument configurations supported by the IEEE-488 infrastructure. Such a HotSpot Interface 244 is configured to receive a payload portion to be transmitted either from the controller 210 to a designated one or more measurement devices 220A-220N, or vice versa, to encapsulate the same with necessary header and protocol-dependent information that allows the wireless transmission process to be successful. Likewise, the HotSpot Interface 244 is also configured to decapsulate all received information, extract the payload portion and send the same to the processing circuitry (not shown) for performing digital processing of the same information. This way the HotSpot Interface 244 can guarantee that the sent and received payload information are identical to the sending and receiving processing circuitry (not shown) as if the information was transmitted over the existing IEEE-488 interface bus with all known cables.

The Wireless Transverser 310 contains a transmitter, a receiver and a processing circuitry (not shown) configured to transmit or receive up to sixteen (16) wireless data and control streams and perform digital processing the same accordingly. The transmitter/receiver can be an integrated component or separate components to perform transmission and reception functions. Each stream (i.e., data or control stream) is a bidirectional stream emulating one of sixteen (16) wires of the standard IEEE-488 interface bus. These streams are as follows:

1) Data Streams:
(a) There are 8 data streams each carrying the transmission of one (1) bit of the data transmitted for a total of eight (8) bits representing a whole byte.
(b) The data streams are binary encoded and decoded at the sending and receiving ends of the processing circuitry (not shown).

2) Control Streams:
(a) The control streams correspond to control lines as defined in the IEEE-488 interface bus. However, every stream carries the transmission of one (1) bit of the control lines as required by the IEEE-488 standard.
(b) The control streams are independent of each other, i.e. there is no need for synchronization or byte encapsulation as in the data streams.
(c) The Control Streams include:
   i. Attention stream
   ii. Ready for data stream
   iii. Data Accept stream
   iv. Data Available stream
   v. Service Request stream
   vi. Interface Clear stream
   vii. Remote Enable stream
   viii. End or Identify stream.

The control streams may represent control signals used to manage the control and data across the interface as required by the IEEE-488 standard. For example, the Attention (ATN) stream may be asserted by the controller 210 to indicate that an address or control byte is being placed on the data bus. The End or Identify (EOI) stream may be asserted simultaneously with the last byte of data to indicate end-of-data transfer of a multi-byte sequence, or asserted along with ATN stream to initiate a parallel poll or end transfers. The Interface Clear (IFC) stream may be used to clear all buffered information and the sending/receiving and receiving/sending ends between the controller 210 and the measurement device 220A-220N being controlled. The Remote Enable (REN) stream may be asserted to enable a device to go into remote mode when addressed to listen. The Service Request (SRQ) stream may be asserted by any device to request action.

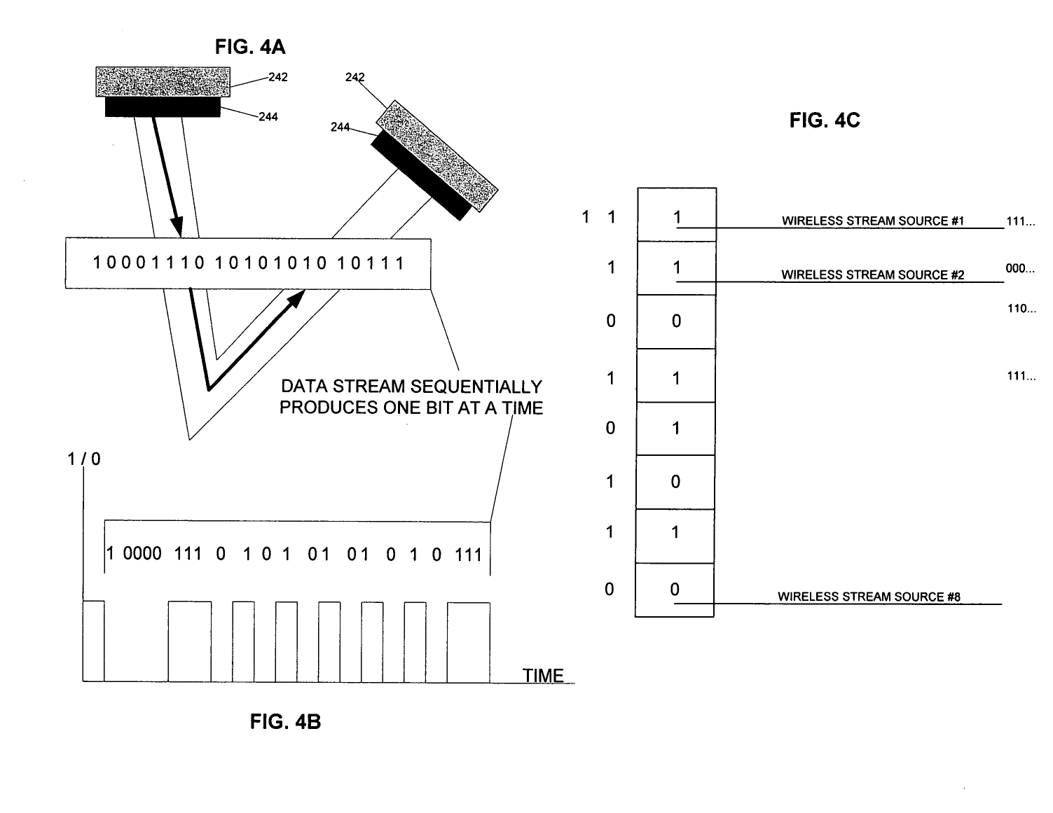

FIGS. 4A-4C illustrate example data streams of the Wireless HotSpot Interface 244 coupled to the standard IEEE-488 interface module 242 according to an embodiment of the present invention. As shown in FIG. 4A, a single data stream is transmitted from a single wireless source, i.e., one Wireless HotSpot Interface 244 coupled to the IEEE-488 interface module 242 to be received at another Wireless HotSpot Interface 244 coupled to another IEEE-488 interface module 242 in a series of “1” and “0”, producing one byte (8 bits) at a time, as viewed in time domain as shown in FIG. 4B, which can then be transferred into a stream of ASCII characters each represented by its 0-255 code. FIG. 4C illustrates up to eight (8) different data streams transmitted from eight (8) different wireless stream sources and received at each Wireless HotSpot Interface 244. With the Wireless HotSpot interface 244, data streams can be received from eight (8) wireless sources simultaneously and processed in accordance with the standard IEEE-488 interface module 242. However, the number of wireless sources, e.g., both the Wireless Access Point (“AP”), i.e., controller 210, and HotSpot client stations, i.e., measurement devices 220A-220N, is not limited to eight (8). For example, as many as 300 wireless sources can be installed within a serviceable HotSpot area without any degradation of performance, as long as data and control streams transmitted simultaneously up to eight (8) wireless sources are processed in parallel at the Wireless HotSpot Interface 244. However, if more than eight (8) wireless stream sources are transmitted data and control streams simultaneously, a multiplexer/demultiplexer arrangement may be utilized to accommodate additional data and control streams.

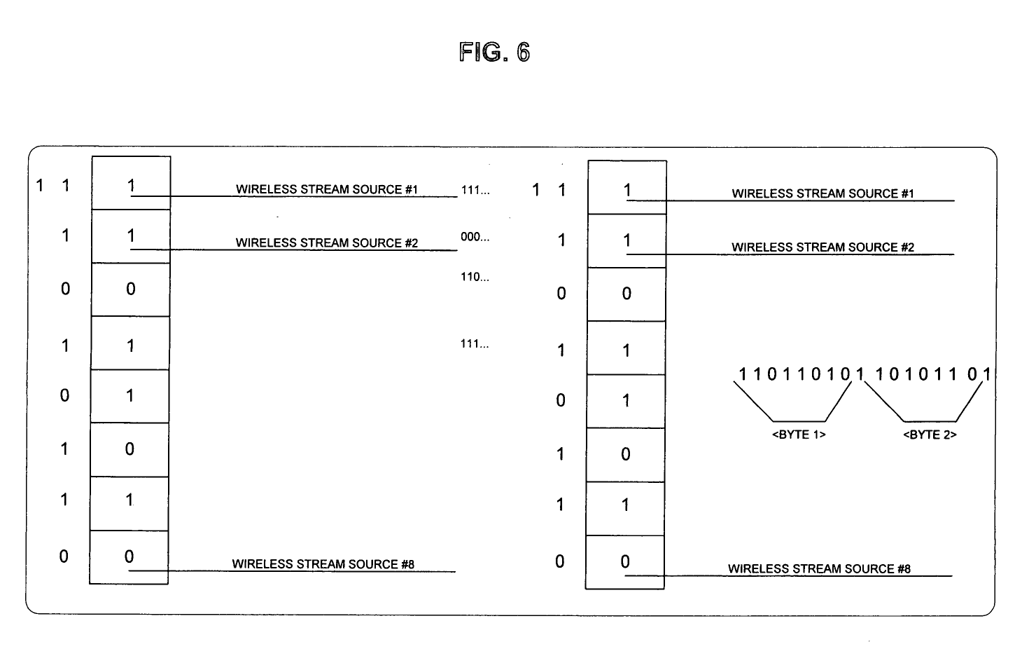

FIG. 5 illustrates example control streams of the Wireless HotSpot Interface according to an embodiment of the present invention. Concurrent to the data streams shown in FIGS. 4A-4C, the control streams can also be transmitted simultaneously from eight (8) different wireless sources, and subsequently received and processed in parallel at the Wireless HotSpot Interface 244. Each control stream is also represented in a series of “1” and “0”, producing one byte (8 bits) at a time, with every 8 bytes representing a character, such as “A”, “B”, “C”. . . Both the data and control streams can be received and processed in parallel at the Wireless HotSpot Interface 244, as shown in FIG. 6.

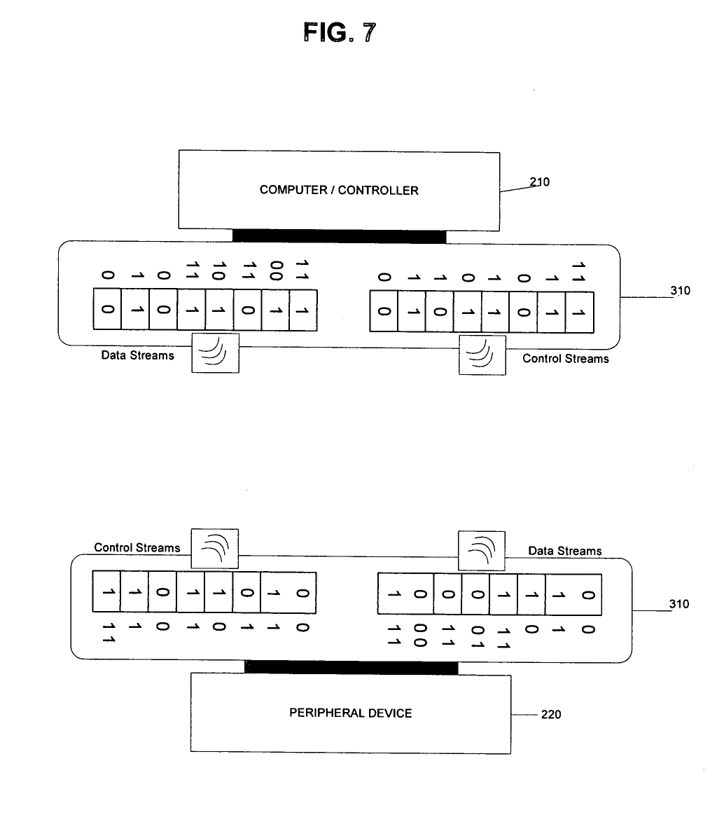

Turning now to FIG. 7, an example interaction between Wireless HotSpot Interfaces installed at a controller 210 and an example measurement device 220 according to an embodiment of the present invention is illustrated. Each Wireless HotSpot Interface 244 is provided with a Wireless Transverser 310 adapted to receive a total of sixteen (16) data and control streams, including eight (8) data streams and eight (8) control streams, transmitted from eight (8) different wireless stream sources.

Referring back to FIG. 3, the Encapsulator 330 is configured to receive a command from the sending controller and adds to the command a header portion that depends on the communication protocol used in wireless transmission. The communication protocol can be, but not limited to, TCP/IP (Transmission Control Protocol/Internet Protocol), UDP (User Defined Protocol), or RTP (Real-time Transport Protocol). For instance, 9 bytes can be added for a TCP/IP transmission. These extra bytes will be the header that allows the receiving end to decapsulate the sent command and make it available in its meaningful for to the receiving measurement device. The Encapsulator 330 may then resume the function of Decapsulator when the sent command is received, processed and get responded to by the receiving end. This role between the Encapsulator 330 and Decapsulator 340 allows one to be the other function wise depends on transmit or receive modes of operation.

The Decapsulator 340 is configured to receive the entire wireless transmission, strips out the header portion that allows partitioning the remainder portion known as the payload into meaningful information for the receiving end. After the received command is recovered from the payload and the receiver responses to the same, the Decapsulator 340 handles the response. The Decapsulator 340 may then resume the function of Encapsulator 330 when the response is ready to be transmitted. Again, the role between the Decapsulator 340 and Encapsulator 330 allows one to be the other function wise depends on transmit or receive modes of operation.

The HotSpot Interface 244 may allow many commands to be sent together. As a result, some of these commands may be executable conditional upon result(s) of other commands. For example, if a measuring voltage command is sent from the controller 210 following by another command to check the current reference voltage at a designated measurement device 220, and if the result exceeds the reference value then, the HotSpot Interface 244 may take a specific action. The scenario of this example can be explained as follows:
a. Measure voltage
b. If Voltage>=RefVoltage then clear the interface and open a circuit.
c. If Voltage<RefVoltage then continue reading next voltage values.

These three (3) commands may take the following “ASCII” format:

Read#1, Voltage
If Voltage >= RefVoltage {
CLR
Open #2, Sw
} else {
Continue
}

On the standard IEEE-488 interface module 242, these commands will be sent as a stream of ASCII characters each represented by its 0-255 code. As a result, a stream of bits will be sent on the IEEE-488 interface module 242 and the function of the receiving end (controller or measurement device) will be to decode each 8 bits into the corresponding ASCII character.

At the Encapsulator 330 of the HotSpot Interface 244, these commands can be augmented together with header identifications, such as, for example:
<Protocol><Number of bytes to follow><Len1><Cmd1><Len2><Cmd2> . . . <checksum>
The protocol can be TCP/IP, UDP, or RTP
Len1=Length of the first command in bytes
Len2 =Length of the second command in bytes, etc.
Checksum=a check sum value that ensures the completeness of the transmission.

All the contents of the encapsulated message will then be transmitted in parallel from the eight (8) wireless sources of the HotSpot Interface 244.

Encapsulation algorithm can be set as follows:
a. Set a protocol byte
b. Set the number of header bytes (such as 9 bytes in the case of TCP/IP)
c. Based on the current packet size, fill-in the next bytes with the transmitted message
d. Calculate and add checksum
e. For the remainder of the transmitted message, build a new packet that starts with the protocol byte, etc
f. Repeat from step (b) until the message is fully transferred.

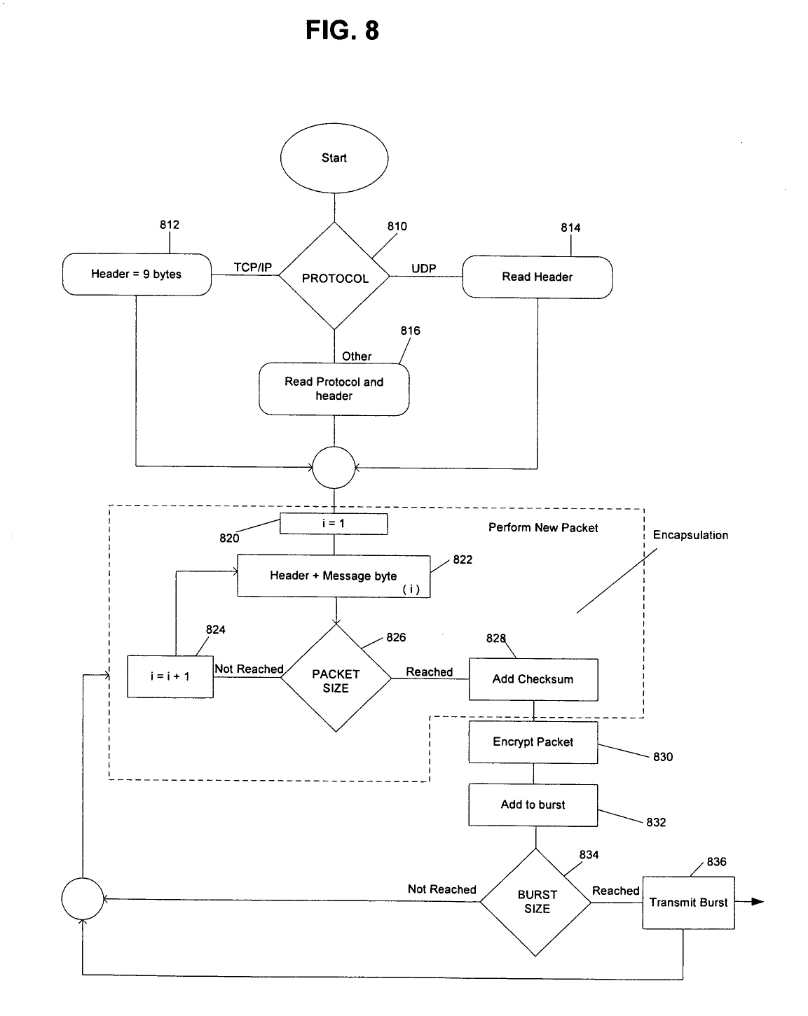

FIG. 8 illustrates an example flowchart of an example Encapsulation algorithm according to an embodiment of the present invention. Before a data message is to be encapsulated and transmitted, via wireless antenna 320, a communication protocol, such as, for example, TCP/IP, UDP or RTP needs to be defined and a proper header needs to be associated with the defined protocol for wireless communication, as shown in blocks 810, 821, 814 and 816, FIG. 8. For example, at block 810, a communication protocol required for wireless communication is determined. If the communication protocol is TCP/IP, then the number of header bytes such as 9 bytes required for TCP/IP transmission is set at block 812. However, if the communication protocol is UDP or other forms of communication protocol such as RTP, then a header is set in accordance with the corresponding protocol, as shown in block 814 and block 816.

After the number of header bytes are set for the corresponding communication protocol, an index (i) is set equal to “1” at block 820 which represents the first byte of a series of bytes representing a command (data and/or control message) to be transmitted, via the wireless antenna 330. The index (i) may contain an identifier unique to the transmitter of the HotSpot Interface 244 which can subsequently be used at the receiver end to associate the command received with a particular transmitter. At block 830, the header and the message byte are combined so as to determine whether a combined packet size has reached at a predetermined packet size at block 826. For example, if the packet size is set (software selectable), for example, at 512 or 1024 bytes, then next bytes representing the command will be added to the packet at block 824 until the packet size is reached. Then, a checksum is added to the combined header and message bytes to constitute a new packet at block 828, which encapsulates the header information, actual message bytes and checksum which indicates to a receiver that the information received is correct.

Each new packet as encapsulated may then be encrypted for security purposes at block 830, and added to a burst of data packets at block 832. As soon as a predetermined burst size (for example, 5000 data packets per burst) is reached at block 834, the burst of data packets (which may represent both control and data streams) can be transmitted, via the wireless antenna 320, at block 836; otherwise, new data packets will need to be encapsulated one-by-one until the burst size is reached at block 836.

Given the main function of the Encapsulator 330 of the HotSpot Interface 320 coupled to, for example, a controller 210, as shown in FIG. 2, and described in connection with FIG. 8, the Decapsulator 340 of the HotSpot Interface 320 coupled to, for example, a measurement device 220 can be utilized to decapsulate the previously encapsulated packets. The Decapsulator's main function is to recover the encapsulated message's individual sub messages and to discard the header and protocol specific extra overhead bytes. In the given example, the decapsulated message will be, for example:
“Read#1, VoltageIf Voltage>=RefVoltage {CLROpen #2, Sw} else {Continue}”

The decapsulated message will then be up to the software of the HotSpot Interface 244 to fetch different parts of the message and to break those different parts of the message back to, for example:

Read#1, Voltage
If Voltage >= RefVoltage {
CLR
Open #2, Sw
} else {
Continue
}

Decapsulation algorithm can be set as follows:
a. Read and decode the protocol byte
b. Read the number of header bytes that are function of the protocol type (such as 9 bytes in the case of TCP/IP)

Based on the current packet size, less the protocol bytes, header bytes and checksum bytes, fetch all other bytes in the contiguous space after the header bytes and before the checksum bytes. These bytes are the transmitted message payload that can be handled by the software of the HotSpot Interface 244.

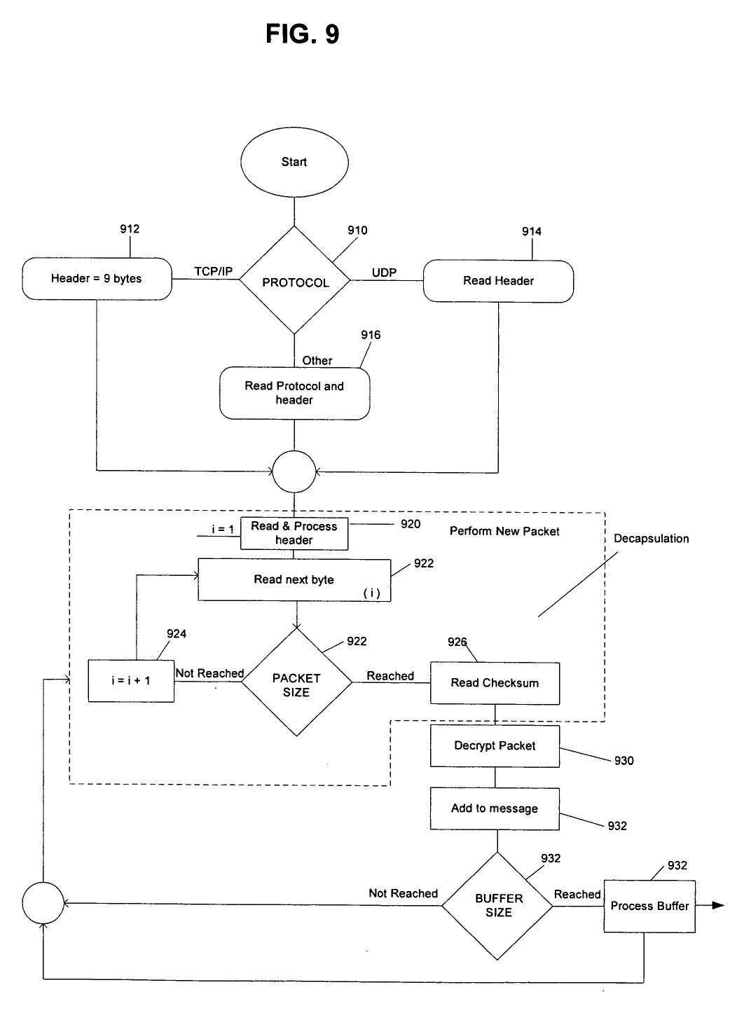

FIG. 9 illustrates an example flowchart of an example Decapsulation algorithm according to an embodiment of the present invention. Similarly to the Encapsulation algorithm, a communication protocol, such as, for example, TCP/IP, UDP or RTP also needs to be defined and a proper header needs to be associated with the defined protocol for wireless communication, as shown in blocks 910, 912, 914 and 916, FIG. 9. For example, at block 910, a communication protocol required for wireless communication is determined. If the communication protocol is TCP/IP, then the number of header bytes such as 9 bytes required for TCP/IP transmission is set at block 912. However, if the communication protocol is UDP or other forms of communication protocol such as RTP, then a header is set in accordance with the corresponding protocol, as shown in block 914 and block 916.

After the number of header bytes is set in advance for the corresponding communication protocol, an incoming burst of packets (message) can be received, via the wireless antenna 320, and decapsulated for signal processing functions. First, each packet as previously encapsulated at the transmitter side is read and its header is decoded, i.e., the number of header bytes that are function of the protocol type) at block 920. A next byte of the transmitted message is then read at block 922 until the packet size has reached at a predetermined packet size at block 926. For example, if the packet size is set (software selectable), for example, at 512 or 1024 bytes, then next bytes representing the command will be added to the packet at block 924 until the packet size is reached. Then, a checksum is read to confirm that the information received is correct. Each new packet as decapsulated may then be encrypted for security purposes at block 830, and added to a message buffer at block 932. As soon as a predetermined buffer size is reached at block 934, the decapsulated packets (which may represent both control and data streams) can be processed accordingly at block 936; otherwise, new data packets will need to be decapsulated one-by-one until the buffer size is reached at block 936.

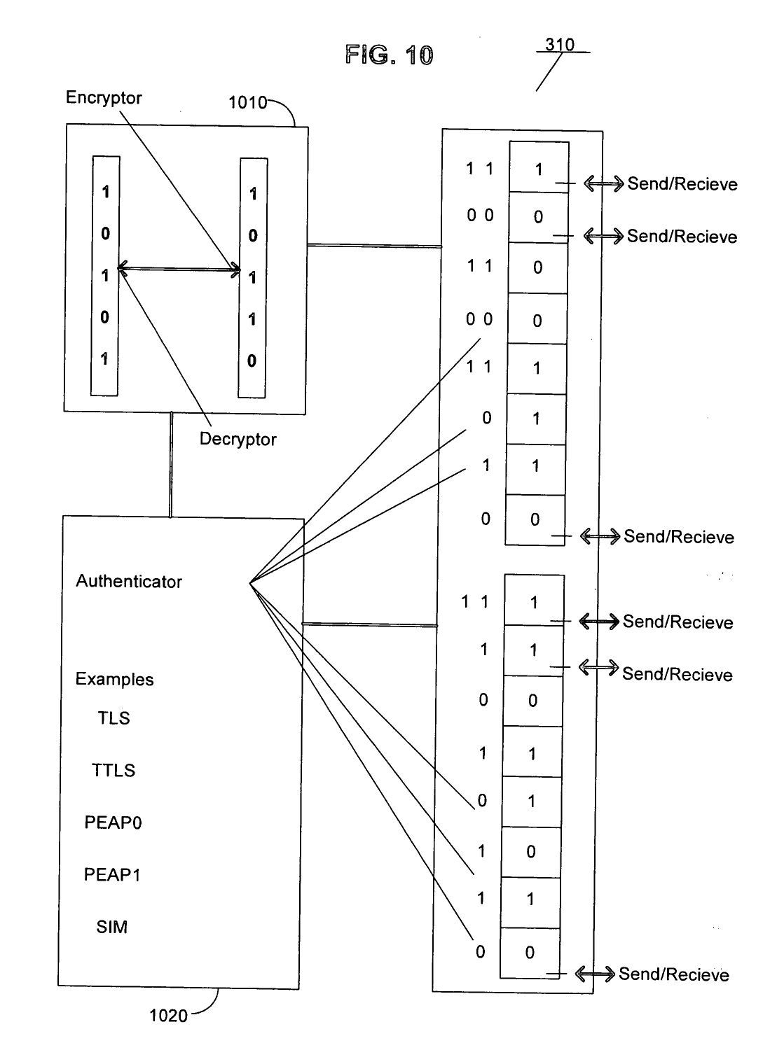

FIG. 10 illustrates an example circuit diagram of a Wireless Transverser according to another embodiment of the present invention. As shown in FIG. 10, the Wireless Transverser 310 may also be provided with an encryptor/decryptor 1010 and an authenticator 1020 for wireless security protection and authentication. The encryptor/decryptor 1010 can be a firmware component that encrypts data transmitted wirelessly according to the “Wired Equivalent Privacy” (WEP) where a WEP flag in the header of the transmitted packet is inserted. In addition, an Integrity Check Value (ICV) may also be inserted in the encrypted portion of the wireless packet transmitted. Similarly, the authenticator 1020 can also be a firmware component that authenticates the client instrument to associate with the controller using Wi-Fi Protection Access (WPA) or the second generation Wi-Fi Protection Access (WPA2) along with the Advanced Encryption Standard (AES). Two ciphers along with WPA can be used. These ciphers include the Temporary Key Integrity protocol “TKIP”, or the Advanced Encryption Standard “AES”. In addition, a separate firmware component can also be implemented to add wireless Multimedia (WMM) differentiated service capability to the transmitted streams. This way data streams of time-critical applications may be prioritized higher than all other types of data or control and management streams.

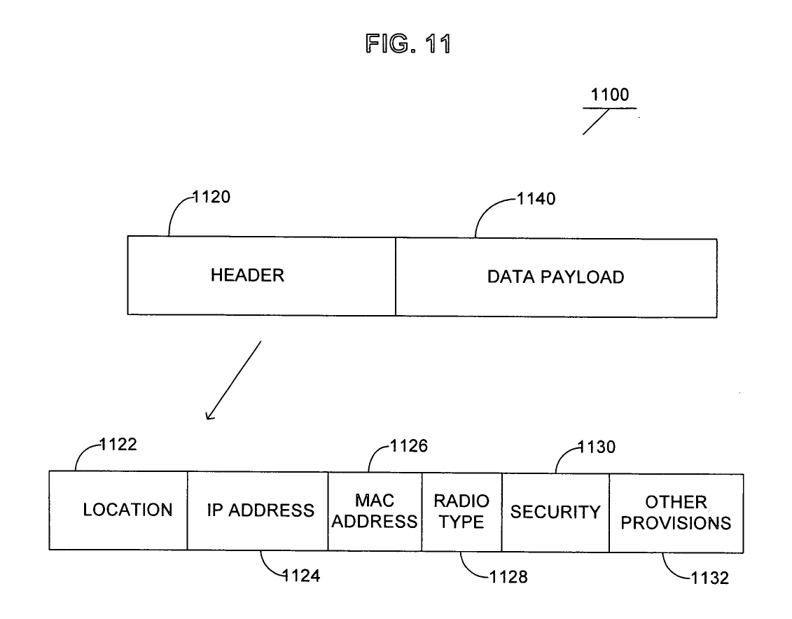

FIG. 11 illustrates an example data packet including provisions for wireless security protection and authentication. As shown in FIG. 11, each data packet 1100 contains a header 1120 and a data payload 1140. The header 1120 comprises a plurality of fields, including, for example, a location field 1122, and IP address field 1124, a MAC address field 1126, a radio type field 1128, a security field 1130, and other provisions 1132. The location field 1122 may be used to describe the location of the access point (controller 210 or measurement device 220, as shown in FIG. 2). The IP address field 1124 may include the unique IP address of the access point (controller 210 or measurement device 200, shown in FIG. 2), while the MAC address 1126 may contain the unique MAC address of the access point (controller 210 or measurement device 220, shown in FIG. 2). Field 1128 may contain the number of radios installed in the access point and define the radio type, for example, such as the IEEE 802.11(a) transverser, IEEE 802.11(b) transverser, or IEEE 802.11(g) transverser. The security field 1130 may illustratively include 64-bit or 128-bit wireless equivalent privacy (WEP) keys under the 802.11 standard, which can be used each access point 138, or any other private keys that allow communication with each access point (controller 210, shown in FIG. 2). Other fields 1132 may include, for example, quality of service information, and the like, as required. For example, a request for services may include various grades of quality-of-service (QoS) information. The grades of service are quality of service levels, which may include constant bit rate (CBR), variable bit rate (VBR), real-time variable bit rate (VBR-RT), controlled load, guarantee service, best effort services, among other services known in the industry. In one embodiment, best effort level of service may be a default level of service. However, in those instances where a user requires requested information without delay or artifacts that may occur when using best effort level of service, the user may request a guaranteed service level, which provides dedicated bandwidth to provide the requested information.

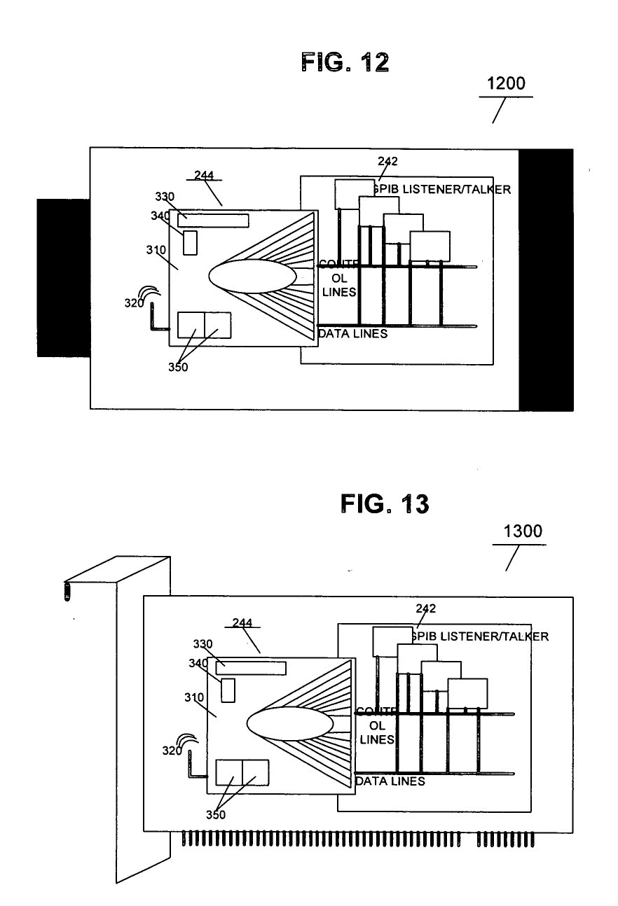

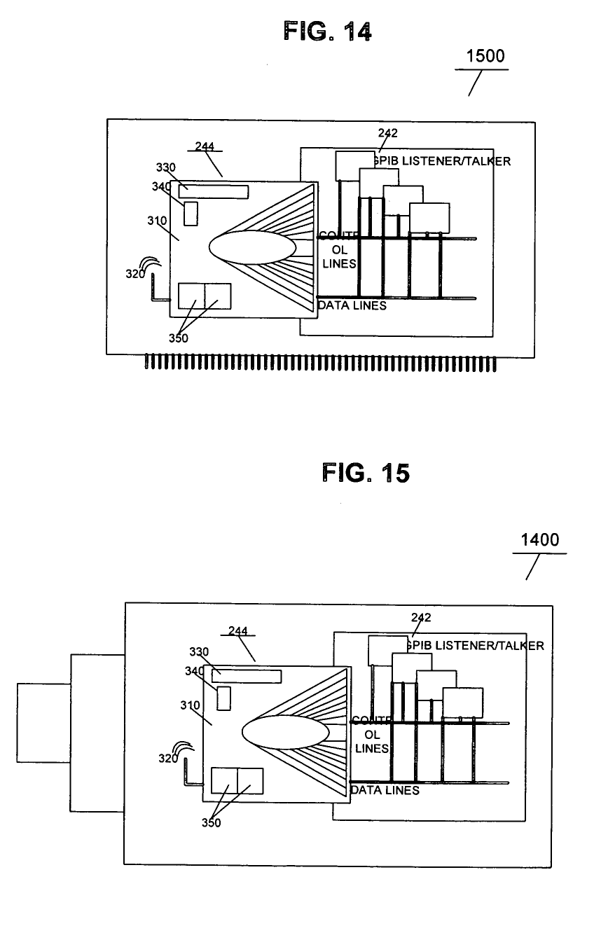

The example Wireless Interface Encapsulator/Decapsulator (“HotSpot Interface”) according to an embodiment of the present invention can also be integrated into standard integrated circuit cards for interchangeability among mobile computers, such as standard personal computers (PCs) and laptops. For example, FIG. 12 illustrates an example Wireless Interface Encapsulator/Decapsulator (“HotSpot Interface”) 244 integrated in a PCMCIA card according to an embodiment of the present invention. The PCMCI (Personal Computer Memory Card International Association) card 1200 is a standard PC card which provides interoperability of not only in mobile computers, but in such diverse products as digital cameras, cable TV, set-top boxes, and automobiles. The Wireless Interface Encapsulator/Decapsulator (“HotSpot Interface”) 244 can simply be integrated onto the processing circuitry of the PCMCI card 1200 along with the existing IEEE-488 interface module 242. Likewise, FIG. 13 illustrates an example Wireless Interface Encapsulator/Decapsulator (“HotSpot Interface”) 244 integrated in a PCI card 1300 according to an embodiment of the present invention. Similarly, FIG. 14 illustrates an example Wireless Interface Encapsulator/Decapsulator (“HotSpot Interface”) 244 integrated in a mini-PCI card 1300 according to an example embodiment of the present invention. The mini PCI (Peripheral Component Interconnect) card 1300 and PCI card 1400 are also standard PC cards used for interoperability on a PCI bus. FIG. 15 illustrates an example Wireless Interface Encapsulator/Decapsulator (“HotSpot Interface”) 244 integrated in a USB2 card according to an example embodiment of the present invention. The USB2 (Universal Serial Bus) card 1500 is the latest standard PC card which enables connecting peripherals to the PC or laptop. As shown in FIG. 12, FIG. 13, FIG. 14 and FIG. 15, the Wireless Interface Encapsulator/Decapsulator (“HotSpot Interface”) 244 according to various examples of the present invention can be portable, compatible and versatile.

Various components of the Wireless Interface Encapsulator/Decapsulator (“HotSpot Interface”) as shown, for example, in FIG. 3, can be implemented in hardware, such as, for example, an application specific integrated circuit (ASIC). As such, it is intended that the processes described herein be broadly interpreted as being equivalently performed by software, hardware, or a combination thereof. Software modules can be written, via a variety of software languages, including C, C++, Java, Visual Basic, and many others. The various software modules may also be integrated in a single application executed on various types of PC cards, such as PCMCIA card shown in FIG. 12, PCI cards shown in FIG. 13 and FIG. 14, and USB card shown in FIG. 15. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the PC cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

As described from the foregoing, the present invention advantageously provides the user with improved tools, wireless interface techniques and means installed in the PC or workstation (controller) and different types of measurement devices (peripherals or instruments) in computer controlled measurement systems to comply with wireless transmission needs as required by the IEEE 802.11(a), 802.11(b) and/or 802.11(9) standards for a wireless local area network, while maintaining backward compatibility with standard IEEE-488 interface bus. The Wireless Interface Encapsulator/Decapsulator (“HotSpot Interface”) is provided to operate with the standard IEEE-488 interface bus, and is capable of receiving and transmitting IEEE-488-compliant signals from and to a set of controllable measurement devices (peripherals or instruments) sharing the bus bandwidth in the wireless domain.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the components of the Wireless HotSpot Interface 244 can be implemented in a single hardware or firmware stalled at an existing IEEE interface module to perform the functions as described. In addition, the wireless network has been described in the context of a telecommunications network having an architecture typical of North America, it should be appreciated that the present invention is not limited to this particular wireless network or protocol. Rather, the invention is applicable to other wireless networks and compatible communication protocols. Moreover, a remote control system can also be set up at a laboratory, research center or testing center to connect to the network, such as the Internet, as shown in FIG. 2, in order to access the Wireless HotSpot (Access Point “AP”), via a gateway (not shown), and control the measurement of individual measurement devices 220A-200N. In addition, measurement devices 220A-220N can also be mobile stations, such as phones or personal digital assistants (PDAs), all of which can also be tested or measured from the controller 210 or at the laboratory, research center or testing center, via the wireless network. Furthermore, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Lastly, both the Encapsulation algorithm and the Decapsulation algorithm as described in connection with FIG. 8 and FIG. 9 can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. A wireless card for use in a host operating in a wireless network, comprising:
an IEEE-488 interface bus; and
a Wireless Interface provided with a Transverser to transmit and receive data and/or control streams from multiple wireless stream sources in parallel, while maintaining backward compatibility with the IEEE-488 interface bus.

2. The wireless card as claimed in claim 1, wherein the Wireless Interface further comprises:
an Encapsulator configured to receive payload data to be transmitted, via a wireless antenna, and encapsulate the payload data with necessary header and protocol-dependent information for wireless transmission, via the antenna; and
a Decapsulator configured to decapsulate all received information, via the wireless antenna, extract the payload data and prepare the payload data for digital processing;
wherein the Encapsulator and the Decapsulator are provided with an interchangible function in transmission and reception modes of operation.

3. The wireless card as claimed in claim 2, wherein the Transverser is configured to receive up to sixteen (16) data and control streams that are transmitted in parallel in the form of packets from up to eight (8) different wireless stream sources, in compliance with the IEEE-488 interface bus.

4. The wireless card as claimed in claim 2, wherein the Transverser comprises:
a transmitter arranged to transmit a data stream and a control stream that are bidirectional in the form of packets, with each stream emulating one of sixteen (16) wires of the IEEE-488 interface bus;
a receiver arranged to receive one or more data streams and control streams in the form of packets from up to eight (8) wireless stream sources, with each stream emulating one of sixteen (16) wires of the IEEE-488 interface bus; and
a processing circuitry configured to perform digital processing all received information after packet decapsulation.

5. The wireless card as claimed in claim 2, wherein the Transverser comprises:
an encryptor/decryptor arranged to encrypt the data and/or control stream to be transmitted, via the antenna, and to decrypt all received information, via the wireless antenna, according to “Wired Equivalent Privacy” (WEP); and
an authenticator arranged to authenticate all received information using Wi-Fi Protection Access (WPA) or a second generation Wi-Fi Protection Access (WPA2) along with the Advanced Encryption Standard (AES).

6. The wireless card as claimed in claim 2, wherein the Encapsulator is configured to:
set header information associated with a defined communication protocol for wireless communication;
add individual bytes representing message information to be transmitted, via the wireless antenna, with the headerinformation until a packet size is reached;
encapsulate a checksum to combined header and message information to form a new packet encapsulating the header and message information and the checksum; and
accumulate encapsulated packets until a burst of packets is obtained for transmission, via the wireless antenna.

7. The wireless card as claimed in claim 6, wherein the Decapsulator is configured to:
set header information associated with a defined communication protocol for wireless communication in advance;
decode header information from received information in the form of packets, via the wireless antenna;
read individual bytes representing message information after the header information is decoded until a packet size is reached;
read the checksum from each packet to form a new packet decapsulating the header and message information and the checksum; and
accumulate decapsulated packets in a buffer until a message is ready for digital signal processing.

8. The wireless card as claimed in claim 2, wherein the wireless card corresponds to one of a PCMCI (Personal Computer Memory Card International Association) card, a PCI (Peripheral Component Interconnect) card, a mini PCI card, and a USB2 (Universal Serial Bus) card installed to connect peripherals to the host, and wherein the host corresponds to a controller or one of different types of measurement devices in a computer controlled measurement system, in which the controller serves as a wireless Access Point (AP) provided to access network resources, via the Internet, while any one of the measurement devices serves as a client station to communicate with the controller, via wireless transmission as specified by IEEE 802.11(a), (b) and/or (g) standards for a wireless local area network (WLAN).

9. A computer controlled measurement system operable in a wireless network, comprising:
a plurality of measurement devices located at different locations in a designated area of the wireless network; and
a controller which serves as a wireless Access Point (AP) to control measurement of the plurality of measurement devices, via wireless communication;
wherein the controller and each of the measurement devices is provided with a Wireless Interface to transmit and receive data and/or control streams representing commands or responses from multiple wireless stream sources in parallel, while maintaining backward compatibility with a standard IEEE-488 interface bus.

10. The computer controlled measurement system as claimed in claim 9, wherein the Wireless Interface comprises:
a Transverser to transmit and receive data and/or control streams representing commands or responses from multiple wireless stream sources in parallel;
an Encapsulator configured to receive payload data to be transmitted, via a wireless antenna, and encapsulate the payload data with necessary header and protocol-dependent information for wireless transmission, via the antenna; and
a Decapsulator configured to decapsulate all received information, via the wireless antenna, extract the payload data and prepare the payload data for digital processing;
wherein the Encapsulator and the Decapsulator are provided with an interchangible function in transmission and reception modes of operation.

11. The computer controlled measurement system as claimed in claim 10, wherein the Transverser is configured to receive up to sixteen (16) data and control streams that are transmitted in parallel in the form of packets from up to eight (8) different wireless stream sources, in compliance with the standard IEEE-488 interface bus.

12. The computer controlled measurement system as claimed in claim 11, wherein the Transverser comprises:
a transmitter arranged to transmit a data stream and a control stream that are bidirectional in the form of packets, with each stream emulating one of sixteen (16) wires of the standard IEEE-488 interface bus;
a receiver arranged to receive one or more data streams and control streams in the form of packets from up to eight (8) wireless stream sources, with each stream emulating one of sixteen (16) wires of the standard IEEE-488 interface bus; and
a processing circuitry configured to perform digital processing all received information after packet decapsulation.

13. The computer controlled measurement system as claimed in claim 10, wherein the Transverser comprises:
an encryptor/decryptor arranged to encrypt the data and/or control stream to be transmitted, via the antenna, and to decrypt all received information, via the wireless antenna, according to “Wired Equivalent Privacy” (WEP); and
an authenticator arranged to authenticate all received information using Wi-Fi Protection Access (WPA) or a second generation Wi-Fi Protection Access (WPA2) along with the Advanced Encryption Standard (AES).

14. The computer controlled measurement system as claimed in claim 10, wherein the Encapsulator is configured to:
set header information associated with a defined communication protocol for wireless communication;
add individual bytes representing message information to be transmitted, via the wireless antenna, with the header information until a packet size is reached;
encapsulate a checksum to combined header and message information to form a new packet encapsulating the header and message information and the checksum; and
accumulate encapsulated packets until a burst of packets is obtained for transmission, via the wireless antenna.

15. The computer controlled measurement system as claimed in claim 14, wherein the Decapsulator is configured to:
set header information associated with a defined communication protocol for wireless communication in advance;
decode header information from received information in the form of packets, via the wireless antenna;
read individual bytes representing message information after the header information is decoded until a packet size is reached;
read the checksum from each packet to form a new packet decapsulating the header and message information and the checksum; and
accumulate decapsulated packets in a buffer until a message is ready for digital signal processing.

16. The computer controlled measurement system as claimed in claim 12, wherein the wireless card corresponds to one of a PCMCI (Personal Computer Memory Card International Association) card, a PCI (Peripheral Component Interconnect)-card, a mini PCI card, and a USB2 (Universal Serial Bus) card.

17. A system, comprising:
a plurality of measurement devices located at different locations in a designated area of the wireless network; and
a controller which serves as a wireless Access Point (AP) to control measurement of the plurality of measurement devices, via wireless communication;
wherein the controller and each of the measurement devices is provided with a Wireless Interface to transmit and receive data and/or control streams representing commands or responses from multiple wireless stream sources in parallel, while maintaining backward compatibility with a standard IEEE-488 interface bus.

18. The system as claimed in claim 17, wherein the Wireless Interface comprises:
a Transverser to transmit and receive data and/or control streams representing commands or responses from multiple wireless stream sources in parallel;
an Encapsulator configured to receive payload data to be transmitted, via a wireless antenna, and encapsulate the payload data with necessary header and protocol-dependent information for wireless transmission, via the antenna; and
a Decapsulator configured to decapsulate all received information, via the wireless antenna, extract the payload data and prepare the payload data for digital processing.

19. The system as claimed in claim 18, wherein the Transverser is configured to receive up to sixteen (16) data and control streams that are transmitted in parallel in the form of packets from up to eight (8) different wireless stream sources, in compliance with the standard IEEE-488 interface bus, and comprises:
a transmitter arranged to transmit a data stream and a control stream that are bidirectional in the form of packets, with each stream emulating one of sixteen (16) wires of the standard IEEE-488 interface bus;
a receiver arranged to receive one or more data streams and control streams in the form of packets from up to eight (8) wireless stream sources, with each stream emulating one of sixteen (16) wires of the IEEE-488 interface bus; and
a processing circuitry configured to perform digital processing all received information after packet decapsulation.

20. The system as claimed in claim 19, wherein the Encapsulator is configured to set header information associated with a defined communication protocol for wireless communication; add individual bytes representing message information to be transmitted, via the wireless antenna, with the header information until a packet size is reached; encapsulate a checksum to combined header and message information to form a new packet encapsulating the header and message information and the checksum; and accumulate encapsulated packets until a burst of packets is obtained for transmission, via the wireless antenna, and
wherein the Decapsulator is configured to set header information associated with a defined communication protocol for wireless communication in advance; decode header information from received information in the form of packets, via the wireless antenna;-read individual bytes representing message information after the header information is decoded until a packet size is reached; read the checksum from each packet to form a new packet decapsulating the header and message information and the checksum; and accumulate decapsulated packets in a buffer until a message is ready for digital signal processing.
